(19) United States
(12) Patent Application Publication
(10) Pub. No.: US 2014/0219243 A1
(43) Pub. Date: Aug. 7, 2014

(54) APPARATUS AND METHODS OF JOINT TRANSMIT POWER AND RESOURCE MANAGEMENT

(71) Applicant: QUALCOMM Incorporated, San Diego, CA (US)

(72) Inventors: Farhad MESHKATI, San Diego, CA (US); Lili ZHANG, San Diego, CA (US); Sumeeth NAGARAJA, San Diego, CA (US); Tamer Adel KADOUS, San Diego, CA (US); Rajat PRAKASH, San Diego, CA (US); Chirag Sureshbhai PATEL, San Diego, CA (US); Mehmet YAVUZ, San Diego, CA (US); Vinay CHANDE, San Diego, CA (US)

(73) Assignee: QUALCOMM Incorporated, San Diego, CA (US)

(21) Appl. No.: 14/026,845

(22) Filed: Sep. 13, 2013

Related U.S. Application Data
(60) Provisional application No. 61/762,242, filed on Feb. 7, 2013.

(51) Int. Cl. H04L 5/00

(52) U.S. Cl. CPC H04L 5/0051
USPC 370/331; 370/329

(57) ABSTRACT

The present disclosure presents a method and apparatus for joint power and resource management in a wireless network. For example, the disclosure presents a method for receiving reference signal received power (RSRP) measurements of one or more neighboring base stations of a base station. In addition, such an example method, may include calibrating a transmit power of the base station based at least on the received measurements, and adjusting transmit resources of the base station in response to the calibration. As such, joint power and resource management in a wireless network may be achieved.

### CLAIM OF PRIORITY UNDER 35 U.S.C. §119

The present application for patent claims priority to U.S. Provisional Patent Application No. 61/762,242, filed Feb. 7, 2013, entitled “Apparatus and Methods of Joint Power and Resource Management,” which is assigned to the assignee hereof, and hereby expressly incorporated by reference herein.

### BACKGROUND

1. Field

The present disclosure relates generally to communication systems, and more particularly, to an apparatus and method of power and resource management.

2. Background

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example of an emerging telecommunication standard is Long Term Evolution (LTE). LTE is a set of enhancements to the Universal Mobile Telecommunications System (UMTS) mobile standard promulgated by Third Generation Partnership Project (3GPP). It is designed to better support mobile broadband Internet access by improving spectral efficiency, lower costs, improve services, make use of new spectrum, and better integrate with other open standards using OFDMA on the downlink (DL), SC-FDMA on the uplink (UL), and multiple-input multiple-output (MIMO) antenna technology. However, as the demand for mobile broadband access continues to increase, there exists a need for further improvements in LTE technology. Preferably, these improvements should be applicable to other multi-access technologies and the telecommunication standards that employ these technologies.

For example, in dense small cell deployments, e.g. where a “small cell” refers to a femtocell or a pico cell having a smaller coverage area than a macro cell, balancing network capacity and user equipment (UE) mobility considerations are important in improving the overall system performance and user experience. On one hand, having many small cells provides spatial reuse and improves the system capacity. On the other hand, having many small cells covering a given region can pose mobility challenges due to pilot pollution, for example, a large number of pilot signals from different base stations having similar received power at a UE.

Thus, there is a desire for a method and apparatus for reducing pilot pollution in a wireless network.

### SUMMARY

Various aspects are now described with reference to the drawings. In the following description, for purposes of explanation, numerous specific details are set forth in order to provide a thorough understanding of one or more aspects. It may be evident, however, that such aspect(s) may be practiced without these specific details. The following presents a simplified summary of one or more aspects in order to provide a basis understanding of such aspects.

The present disclosure presents an example method and apparatus for joint power and resource management in a wireless network. For example, the present disclosure presents an example method for joint power and resource management that includes receiving reference signal received power (RSRP) measurements of one or more neighboring base stations of a base station. In addition, such method may include calibrating a transmit power of the base station based at least on the received measurements and adjusting transmit resources of the base station at least in response to the calibrating.

In an additional aspect, the present disclosure presents an example apparatus for joint power and resource management in a wireless network which may include means for receiving reference signal received power (RSRP) measurements of one or more neighboring base stations of a base station. In addition, such apparatus may include means for calibrating a transmit power of the base station based at least on the received measurements, and means for adjusting transmit resources of the base station at least in response to the calibrating.

Moreover, the present disclosure presents an example computer program product for joint power and resource management in a wireless network which may include a computer-readable medium comprising code for receiving reference signal received power (RSRP) measurements of one or more neighboring base stations of a base station. In addition, such computer program product may include code for calibrating a transmit power of the base station based at least on the received measurements and code for adjusting transmit resources of the base station at least in response to the calibrating.

In a further aspect, the present disclosure presents an example apparatus for joint power and resource management in a wireless network which may include a joint power and resource manager to receive reference signal received power (RSRP) measurements of one or more neighboring base stations of a base station. In addition, such apparatus may include a transmit power calibrator component to calibrate a transmit power of the base station based at least on the received measurements and a resource management component to adjust transmit resources of the base station at least in response to the calibration.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is schematic diagram of a network architecture including an aspect of a joint power and resource manager;

FIG. 2 is a flowchart of an aspect of joint power and resource management in a wireless network;

FIG. 3 is a diagram illustrating an example of a network architecture;

FIG. 4 is a block diagram illustrating aspects of a logical grouping of electrical components as contemplated by the present disclosure;

FIG. 5 is a block diagram illustrating an example of a hardware implementation for an apparatus employing a processing system;

FIG. 6 is a block diagram conceptually illustrating an example of a telecommunications system;

FIG. 7 is a conceptual diagram illustrating an example of an access network; and

FIG. 8 is a block diagram conceptually illustrating an example of a NodeB in communication with a UE in a telecommunications system.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

The present disclosure provides apparatus and methods for joint power and resource management in a wireless network by receiving reference signal receiving reference signal received power (RSRP) measurements of one or more neighboring base stations of a base station, calibrating a transmit power of the base station based at least on the received measurements, and managing transmit resources of the base station in response to the calibrating.

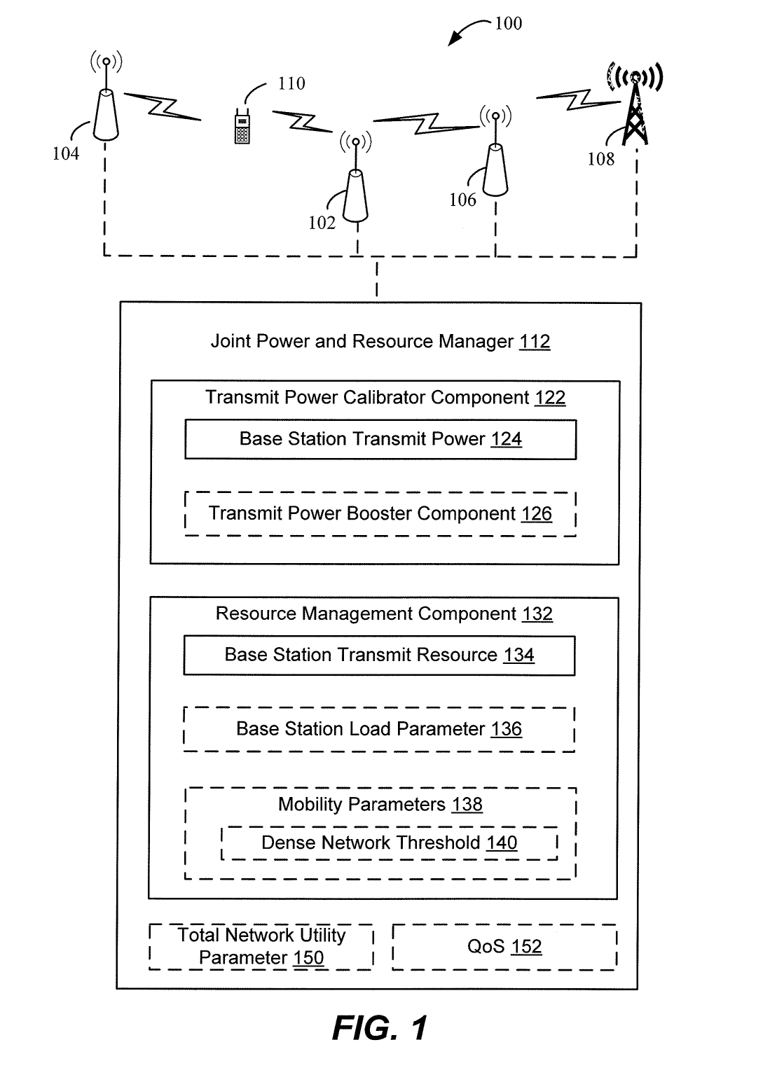

Referring to FIG. 1, a wireless communication system 100 is illustrated that facilitates joint transmit power and resource management to balance capacity and mobility considerations in heterogeneous networks.

In an aspect, for example, system 100 may include a joint power and resource manager component 112 that may be configured to adjust a base station transmit power 124 and adjust a base station transmit resource 134 of one or more of a plurality of base stations to reduce pilot pollution at a user equipment (UE) 110.

For example, UE 110 may be located in a dense network with a plurality of base stations, such as serving small coverage base station 102, neighboring small coverage base stations 104 and 106 and one or more macro base stations 108. The term “small coverage” base station refers to, for example, a femtocell or a pico cell having a coverage area substantially less than a coverage area of a macro base station. In such dense deployments, UE 110 may experience pilot pollution. The term “pilot pollution” as used herein may include, for example, a situation where UE 110 receives a large number of pilot signals from different base stations having similar power levels at the UE. For example, a large number of pilot signals and/or common reference signals (CRSs) received at UE 110 from base stations 102, 104, 106, and/or 108 may have a similar received power level. Further, it should be noted that although the dense network scenario described herein is not limited to the example of a number of small coverage base stations and a macro base station, but may include any combination of any number and/or any type of base stations. Also, it should be noted that joint power and resource manager component 112, may be a part of one or more of base stations 102, 104, 106, and/or 108, or may be located in a separate network entity in communication with one or more of base stations 102, 104, 106, and/or 108.

In an aspect, joint power and resource manager component 112 may include a transmit power calibrator component 122 and a resource management component 132 that may be configured to balance UE mobility and network capacity considerations to improve overall performance of system 100.

In an aspect, transmit power calibrator component 122 may be configured to adjust base station transmit power 124, for example, for serving small coverage base station 102 or any or all of the plurality of base stations in system 100, based on signals detected or received from one or more of the other one of the plurality of base stations.

For example, for serving base station 102, transmit power calibrator component 122 may obtain measurements of received signals, for example, pilot signals or CRS signals from neighboring small coverage base stations 104 and 106 and/or optionally from macro base station 108. In an additional aspect, for example, transmit power calibrator component 122 may obtain measurements of the received signals (for example, referred to as “network listen measurements”) from a network listening module (NLM) located at base station 102. In another aspect, transmit power calibrator component 122 may obtain measurements of the received signals from UE 110, for example, in a measurement report, either directly from UE 110 or via serving base station 102 and/or one of the other base stations 104, 106, and/or 108 when joint power and resource manager component 112 is located in another network entity.

In an aspect, for example, transmit power calibrator component 122 may adjust base station transmit power 124 based on the level of the received signals. In other words, transmit power calibrator component 122 may take into account existing signaling in the coverage area of serving small coverage base station 102 in order to adjust base station transmit power 124 to reduce the potential for any interference. For example, transmit power calibrator component 122 may adjust base station transmit power 124 based on a function or a mapping between one or more received power levels of the received signals and one or more levels of base station transmit power 124. In another aspect, base station transmit power 124 pertains to a power level of a pilot signal, such as a CRS signal, broadcast by the base station.

In an aspect, to decouple mobility from capacity, the base stations of system 100 may use colliding CRS signals. For example, a DeModulation Reference Signal (DMRS) can be used for channel estimation and data decoding. As such, in an example aspect, base station transmit power 124 pertains to the power level of the CRS signal of the base station, but the power level of a data signal may be independently determined. In other words, transmit power calibrator component 122 and/or resource manager component 132 may respectively adjust the base station transmit power 124 and/or base station transmit resource 134 for a data transmission independently of the base station transmit power/resources for a CRS. Additionally, and in conjunction with the operation of transmit power calibrator component 122, resource management component 132 can adjust base station transmit resource 134 to reduce interference with the other base stations. For example, in an aspect, resource management component 132 may orthogonalize base station transmit resource 134 to reduce interference caused by neighboring base stations. In an example aspect, the transmit resources may be orthogonalized in a time domain or a frequency domain. For example, in an aspect, resource management component 132 may orthogonalize base station transmit resource 134 in a frequency domain using a fractional frequency reuse (FFR) procedure or a soft FFR procedure for the data channels combined with interference cancellation of control channels. In an additional aspect, for example, resource management component 132 may orthogonalize base station transmit resource 134 in a time domain. For example, one or more of the base stations 104, 106, and/or 108 may reduce or turn off transmission during certain time slots to reduce interference to UE 110 served by base station 102.

In an additional or optional aspect, resource management component 132 may be configured to adjust base station transmit resource 134 further based on a base station load parameter 136 in order to balance load across system 100. For example, base station load parameter 136 may be an actual load value determined by the base station or a factor of base station transmit power 124. For instance, since operation of transmit power calibrator component 122 can result in load imbalance between neighboring small coverage base stations, for example, one small coverage base station with a higher transmit power would serve more users compared to a neighboring small coverage base station with a lower power, resource management component 132 can take this into consideration in assigning base station transmit resource 134, for example, frequency/time resources, to neighboring small coverage base stations to overcome the load imbalance.

In an additional or optional aspect, transmit power calibrator component 122 may include a transmit power booster component 126 that may be configured to adjust base station transmit power 124. For example, transmit power booster component 126 may configure a base station, for example, serving small coverage base station 102, with a periodic increase in base station transmit power 124 for a temporary time period. As such, this enables base stations with relatively lower base station transmit power to temporarily increase their transmit power level to attract UEs, for example, UEs in idle and/or connected state. The temporary time period during which the transmit power is booted may be configured to a value that is considered sufficient by the network to enable UEs to search and discover the base stations and thereby perform reselection or handover procedures, if appropriate.

In a further additional or optional aspect, joint power and resource manager 112 may provide UE 110 with mobility parameters 138 including one or more dense network thresholds 138 to reduce reselection or handover from a serving base station. For example, dense network thresholds 140 may be threshold values higher than standard threshold values for a given mobility parameter, for example, received signal power, so that UE 110 may maintain an association with the serving base station. In particular, joint power and resource manager component 122 may further provide UE 110 with mobility parameters 138 having one or more dense network thresholds 140 for use when the serving base station, for example, serving small coverage base station 102, is operating under a reduced transmit power level based on execution of transmit power calibrator component 122 to adjust base station transmit power 124.

In a further optional or additional aspect, transmit power calibrator component 122 is configured to adjust base station transmit power 124 and resource manager component 132 is configured to adjust base station transmit resource 134 in a coordinated fashion to maximize a total network utility parameter 150 while maintaining a Quality of Service (QoS) level 152. For example, total network utility parameter 150 may be a sum of rates or a sum of logarithm of rates of all UEs in system 100, while QoS level 152 may be a minimum QoS rate for all UEs in system 100.

Therefore, according to the present apparatus and methods, joint power and resource manager 112 balances UE mobility considerations with network capacity considerations to adjust base station transmit power 124 and to adjust base station transmit resource 132 for one or more of a plurality of base stations, to reduce pilot pollution at user equipment 110 served by small power base station 102.

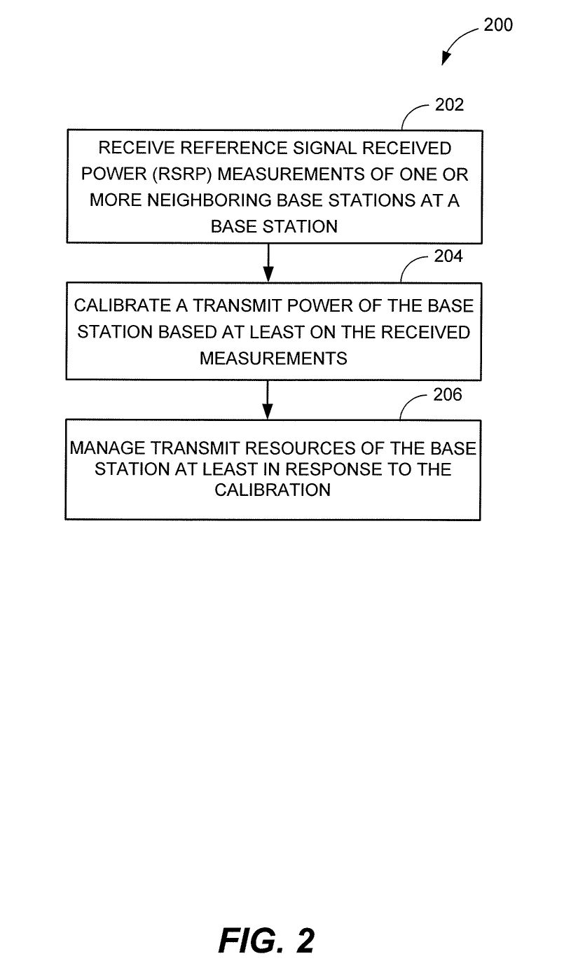

FIG. 2 illustrates an example methodology 200 for joint power and resource management in a wireless network. In an aspect, at block 202, methodology 200 may include receiving reference signal received power (RSRP) measurements of one or more neighboring base stations at a base station. For example, serving small coverage base station 102 and/or joint power and resource manager 112 may receive reference signal received power (RSRP) measurements of one more neighboring base stations, for example, 104, 106, and/or 108, from a UE, for example, UE 110.

Further, at block 204, methodology 200 may include calibrating a transmit power of the base station based at least on the received measurements. For example, in an aspect, base station 102 and/or joint power and resource manager 112 and/or transmit power calibrator component 122 may calibrate transmit power of the base station, for example, serving base station 102, based at least on the received RSRP measurements.

Furthermore, at block 206, methodology 200 may include adjusting transmit resources of the base station at least in response to the calibrating. For example, in an aspect, base station 102 and/or joint power and resource manager 112 and/or resource management component 132 may adjust transmit resources of the base station, for example, serving base station 102, in response to the calibration of the transmit power of the base station 102.

For example, performing the transmit power calibration may include receiving one or more measurements of a reference signal, such as a CRS, corresponding to each of the other base stations, and adjusting a level of the base station transmit power based on the received measurements. For instance, receiving one or more measurements of a reference signal may include receiving a user equipment measurement report of measurement of the signaling at the user equipment, receiving a report from the base station of the user equipment measurement report or of measurement of the signaling at the base station, receiving a report from the other base stations of the user equipment measurement report or of measurement of the signaling at the other base stations, or measuring the signaling at the base station.

In an aspect, performing the transmit power calibration further comprises configuring a periodic transmission power level increase for a temporary time period as described above.

In an aspect, the performing of the resource management calibration includes adjusting the base station transmit resource based on a load parameter. The load parameter may include, but is not limited to, one or more of available backhaul capacity, a number of UEs being served by a base station, a number of UEs camping on a base station, an available bandwidth, or other similar load-related parameters. Moreover, in some aspects, the resource management and/or transmit power calibration may include adjusting the base station transmit resource and/or transmit power based on availability and/or available capacity of a backhaul interface.

In an aspect, the performing of the resource management calibration further comprises configuring one or more mobility parameters for use by a user equipment being served by the base station, wherein the mobility parameters comprises one or more dense network thresholds that reduce handover or reselection of the user equipment from the base station to one of the other base stations.

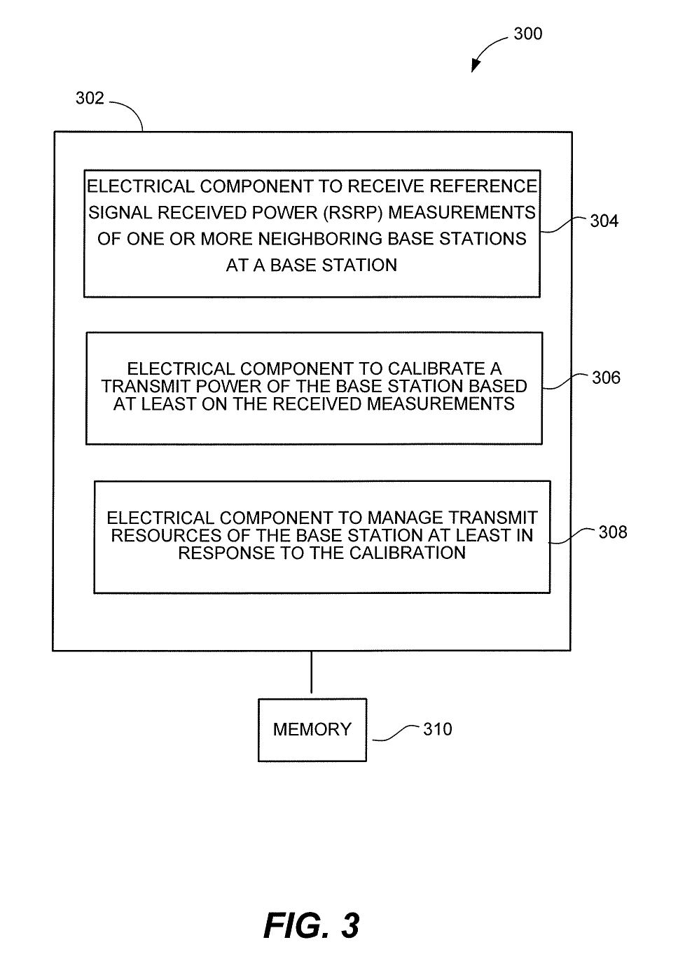

Referring to FIG. 3, an example system 300 is displayed for joint transmit power and resource management for wireless communication. For example, system 300 can reside at least partially within a base station, for example, base station 102 (FIG. 1). It is to be appreciated that system 300 is represented as including functional blocks, which can be functional blocks that represent functions implemented by a processor, software, or combination thereof (for example, firmware). System 300 includes a logical grouping 302 of electrical components that can act in conjunction. For instance, logical grouping 302 may include an electrical component 304 for receiving reference signal received power (RSRP) measurements of one or more neighboring base stations at a base station. In an aspect, electrical component 304 may comprise joint power and resource manager 112 and/or transmit power calibrator component 122 (FIG. 1).

Additionally, logical grouping 302 may include an electrical component 306 for calibrating a transmit power of the base station based at least on the received measurements. In an aspect, electrical component 306 may comprise calibrating transmit power of the base stations, for example, serving base station 102, based at least on the received measurements. In an additional or optional aspect, logical grouping 306 may optionally include transmit power booster component 126 (FIG. 1).

Additionally, logical grouping 302 can include an electrical component 308 for managing transmit resources of the base station in response to the calibrating. In an aspect, electrical component 308 may comprise adjusting transmit resources of base station 102 in response to calibration of the transmit power of base station 102.

Additionally, system 300 can include a memory 310 that retains instructions for executing functions associated with the electrical components 304, 306, and 308, stores data used or obtained by the electrical components 304, 306, and 308 etc. While shown as being external to memory 310 it is to be understood that one or more of the electrical components 304, 306, and 308 can exist within memory 310. In one example, electrical components 304, 306, and 308 can comprise at least one processor, or each electrical component 304, 306, and 308 can be a corresponding module of at least one processor. Moreover, in an additional or alternative example, electrical components 304, 306, and 308 can be a computer program product including a computer readable medium, where each electrical component 304, 306, and 308 can be corresponding code.

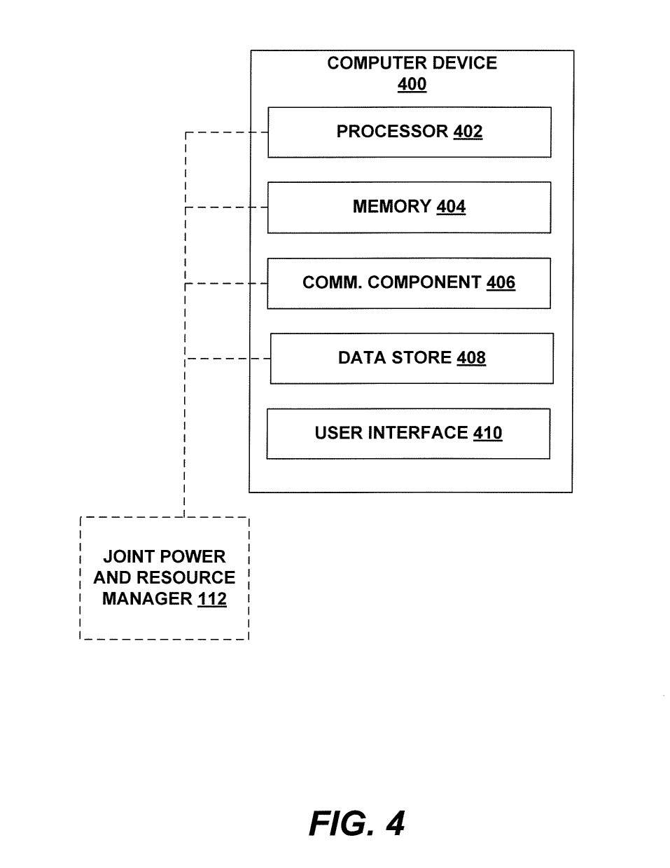

Referring to FIG. 4, in one aspect, any of base station 102, 104, 106, and 108, including joint power and resource manager 112 (FIG. 1) may be represented by a specially programmed or configured computer device 400. In one aspect of implementation, computer device 400 may include joint power and resource manager 122 and/or transmit power calibrator component 122 and/or resource management component 132 (FIG. 1), such as in specially programmed computer readable instructions or code, firmware, hardware, or some combination thereof. Computer device 400 includes a processor 402 for carrying out processing functions associated with one or more of components and functions described herein. Processor 402 can include a single or multiple set of processors or multi-core processors. Moreover, processor 402 can be implemented as an integrated processing system and/or a distributed processing system.

Computer device 400 further includes a memory 404, such as for storing data used herein and/or local versions of applications being executed by processor 402. Memory 404 can include any type of memory usable by a computer, such as random access memory (RAM), read only memory (ROM), tapes, magnetic discs, optical discs, volatile memory, non-volatile memory, and any combination thereof.

Further, computer device 400 includes a communications component 406 that provides for establishing and maintaining communications with one or more parties utilizing hardware, software, and services as described herein. Communications component 406 may carry communications between components on computer device 400, as well as between computer device 400 and external devices, such as devices located across a communications network and/or devices serially or locally connected to computer device 400. For example, communications component 406 may include one or more buses, and may further include transmit chain components and receive chain components associated with a transmitter and receiver, respectively, or a transceiver, operable for interfacing with external devices. In an additional aspect, communications component 406 may be configured to receive one or more pages from one or more subscriber networks. In a further aspect, such a page may correspond to the second subscription and may be received via the first technology type communication services.

Additionally, computer device 400 may further include a data store 408, which can be any suitable combination of hardware and/or software, that provides for mass storage of information, databases, and programs employed in connection with aspects described herein. For example, data store 408 may be a data repository for applications not currently being executed by processor 402 and/or any threshold values or finger position values.

Computer device 400 may additionally include a user interface component 410 operable to receive inputs from a user of computer device 400 and further operable to generate outputs for presentation to the user. User interface component 410 may include one or more input devices, including but not limited to a keyboard, a number pad, a mouse, a touch-sensitive display, a navigation key, a function key, a microphone, a voice recognition component, any other mechanism capable of receiving an input from a user, or any combination thereof. Further, user interface component 410 may include one or more output devices, including but not limited to a display, a speaker, a haptic feedback mechanism, a printer, any other mechanism capable of presenting an output to a user, or any combination thereof.

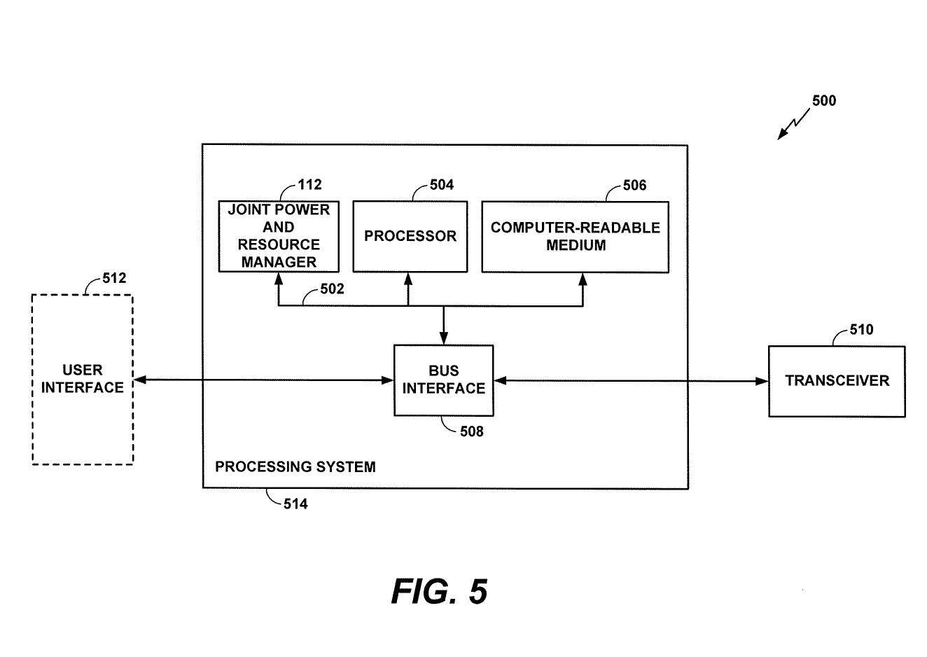

FIG. 5 is a block diagram illustrating an example of a hardware implementation for an apparatus 500, for example, including joint power and resource manager 112 of FIG. 1, employing a processing system 514 for carrying out aspects of the present disclosure, such as method for joint power and resource management. In this example, the processing system 514 may be implemented with a bus architecture, represented generally by a bus 502. The bus 502 may include any number of interconnecting buses and bridges depending on the specific application of the processing system 514 and the overall design constraints. The bus 502 links together various circuits including one or more processors, represented generally by the processor 504, computer-readable media, represented generally by the computer-readable medium 505, and one or more components described herein, such as, but not limited to, joint power and resource manager 112 and/or transmit power calibrator component 122 and/or resource management component 132 (FIG. 1). The bus 502 may also link various other circuits such as timing sources, peripherals, voltage regulators, and power management circuits, which are well known in the art, and therefore, will not be described any further. A bus interface 508 provides an interface between the bus 502 and a transceiver 510. The transceiver 510 provides a means for communicating with various other apparatus over a transmission medium. Depending upon the nature of the apparatus, a user interface 512 (e.g., keypad, display, speaker, microphone, joystick) may also be provided.

The processor 504 is responsible for managing the bus 502 and general processing, including the execution of software stored on the computer-readable medium 505. The software, when executed by the processor 504, causes the processing system 514 to perform the various functions described infra for any particular apparatus. The computer-readable medium 505 may also be used for storing data that is manipulated by the processor 504 when executing software.

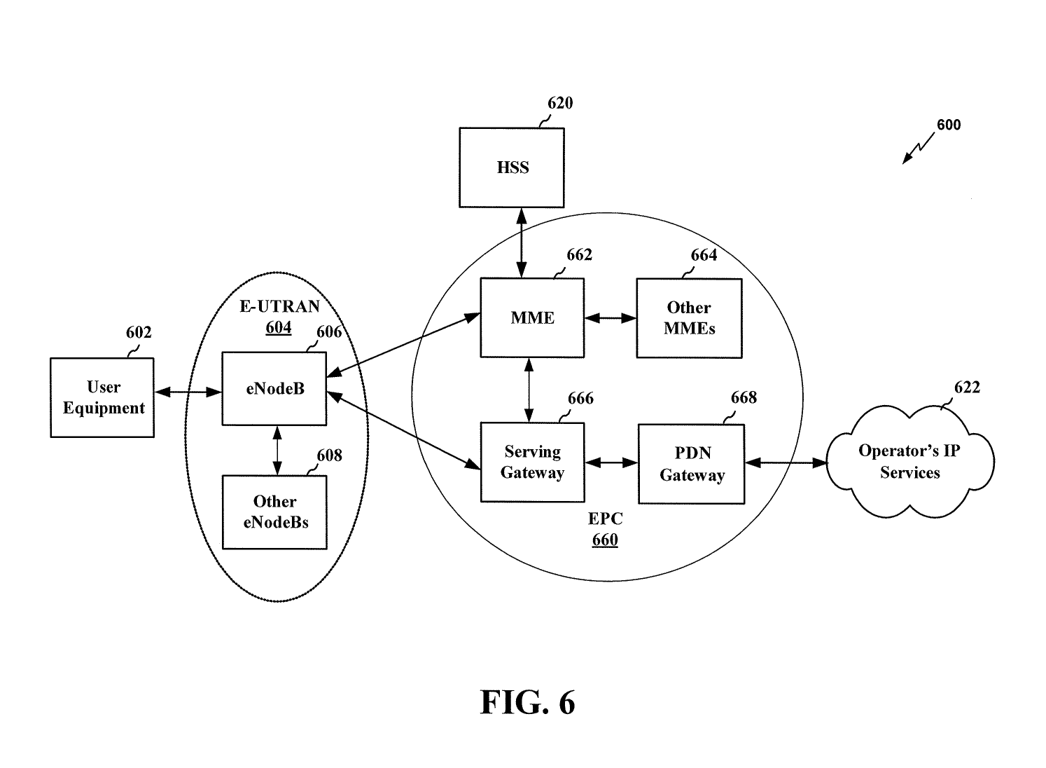

FIG. 6 is a diagram illustrating a long term evolution (LTE) network architecture 600 employing various apparatuses of wireless communication system 100 (FIG. 1) and may include one or more base stations configured to include a joint power and resource manager 112 (FIG. 1). The LTE network architecture 600 may be referred to as an Evolved Packet System (EPS) 600. EPS 600 may include one or more user equipment (UE) 602, an Evolved UMTS Terrestrial Radio Access Network (E-UTRAN) 604, an Evolved Packet Core (EPC) 660, a Home Subscriber Server (HSS) 620, and an Operator's IP Services 622. The EPS can interconnect with other access networks, but for simplicity those entities/interfaces are not shown. As shown, the EPS provides packet-switched services, however, as those skilled in the art will readily appreciate, the various concepts presented throughout this disclosure may be extended to networks providing circuit-switched services.

The E-UTRAN includes the evolved Node B (eNB) 606 and other eNBs 608. The eNB 606 provides user and control plane protocol terminations toward the UE 602. The eNB 606 may be connected to the other eNBs 608 via an X2 interface (i.e., backhaul). The eNB 606 may also be referred to by those skilled in the art as a base station, a base transceiver station, a radio base station, a radio transceiver, a transceiver function, a basic service set (BSS), an extended service set (ESS), or some other suitable terminology. The eNB 606 provides an access point to the EPC 660 for a UE 602. Examples of UEs 602 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, or any other similar functioning device. The UE 602 may also be referred to by those skilled in the art as a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology.

The eNB 606 is connected by an S1 interface to the EPC 660. The EPC 660 includes a Mobility Management Entity (MME) 662, other MMEs 664, a Serving Gateway 666, and a Packet Data Network (PDN) Gateway 668. The MME 662 is the control node that processes the signaling between the UE 602 and the EPC 610. Generally, the MME 612 provides bearer and connection management. All user IP packets are transferred through the Serving Gateway 666, which itself is connected to the PDN Gateway 668. The PDN Gateway 668 provides UE IP address allocation as well as other functions. The PDN Gateway 668 is connected to the Operator's IP Services 622. The Operator's IP Services 622 include the Internet, the Intranet, an IP Multimedia Subsystem (IMS), and a PS Streaming Service (PSS).

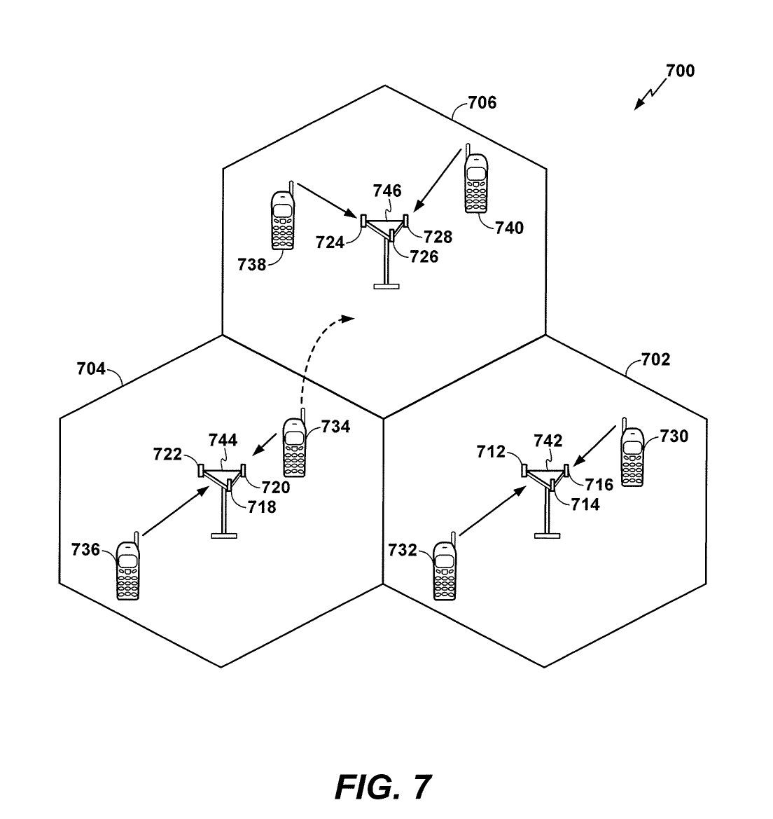

Referring to FIG. 7, an access network 700 in a UTRAN architecture is illustrated, and may include one or more base stations configured to include a joint power and resource manager 112 (FIG. 1). The multiple access wireless communication system includes multiple cellular regions (cells), including cells 702, 704, and 706, each of which may include one or more sectors and which may base station 102, 104, 106, and/or 108 of FIG. 1. The multiple sectors can be formed by groups of antennas with each antenna responsible for communication with UEs in a portion of the cell. For example, in cell 702, antenna groups 712, 714, and 716 may each correspond to a different sector. In cell 704, antenna groups 717, 720, and 722 each correspond to a different sector. In cell 706, antenna groups 724, 726, and 728 each correspond to a different sector. The cells 702, 704 and 706 may include several wireless communication devices, e.g., User Equipment or UEs, for example, including UE 110 of FIG. 1, which may be in communication with one or more sectors of each cell 702, 704 or 706. For example, UEs 730 and 732 may be in communication with NodeB 742, UEs 734 and 736 may be in communication with NodeB 744, and UEs 737 and 740 can be in communication with NodeB 746. Here, each NodeB 742, 744, 746 is configured to provide an access point for all the UEs 730, 732, 734, 736, 738, 740 in the respective cells 702, 704, and 706. Additionally, each NodeB 742, 744, 746 and UEs 730, 732, 734, 736, 738, 740 may be UE 102 of FIG. 1 and may perform the methods outlined herein.

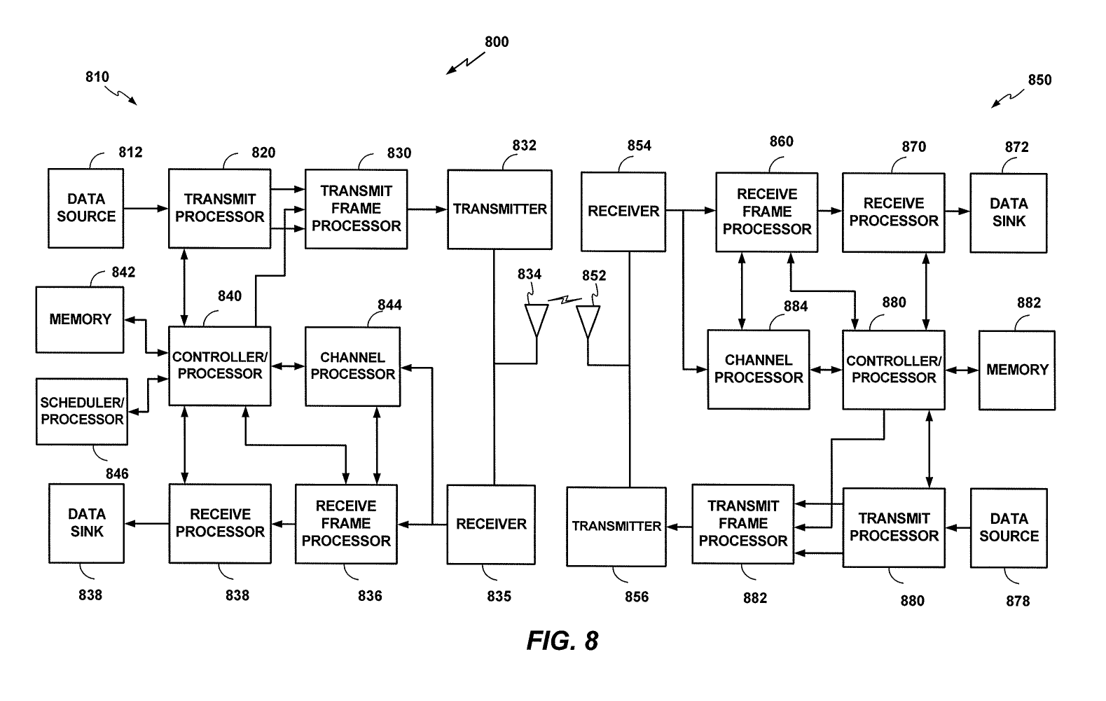

As the UE 734 moves from the illustrated location in cell 704 into cell 706, a serving cell change (SCC) or handover may occur in which communication with the UE 734 transitions from the cell 704, which may be referred to as the source cell, to cell 706, which may be referred to as the target cell. Management of the handover procedure may take place at the UE 734, at the Node Bs corresponding to the respective cells, at a radio network controller 806 (FIG. 8), or at another suitable node in the wireless network. For example, during a call with the source cell 704, or at any other time, the UE 734 may monitor various parameters of the source cell 704 as well as various parameters of neighboring cells such as cells 706 and 702. Further, depending on the quality of these parameters, the UE 734 may maintain communication with one or more of the neighboring cells. During this time, the UE 734 may maintain an Active Set, that is, a list of cells that the UE 734 is simultaneously connected to (i.e., the UTRA cells that are currently assigning a downlink dedicated physical channel DPCH or fractional downlink dedicated physical channel F-DPCH to the UE 734 may constitute the Active Set). In any case, UE 734 may execute reselection manager 104 to perform the reselection operations described herein.

Further, the modulation and multiple access scheme employed by the access network 700 may vary depending on the particular telecommunications standard being deployed. By way of example, the standard may include Evolution-Data Optimized (EV-DO) or Ultra Mobile Broadband (UMB). EV-DO and UMB are air interface standards promulgated by the 3rd Generation Partnership Project 2 (3GPP2) as part of the CDMA2000 family of standards and employs CDMA to provide broadband Internet access to mobile stations. The standard may alternately be Universal Terrestrial Radio Access (UTRA) employing Wideband-CDMA (W-CDMA) and other variants of CDMA, such as TD-SCDMA; Global System for Mobile Communications (GSM) employing TDMA; and Evolved UTRA (E-UTRA), Ultra Mobile Broadband (UMB), IEEE 902.11 (Wi-Fi), IEEE 902.16 (WiMAX), IEEE 902.20, and Flash-OFDM employing OFDMA. UTRA, E-UTRA, UMTS, LTE, LTE Advanced, and GSM are described in documents from the 3GPP organization. CDMA2000 and UMB are described in documents from the 3GPP2 organization. The actual wireless communication standard and the multiple access technology employed will depend on the specific application and the overall design constraints imposed on the system.

FIG. 8 is a block diagram of a NodeB 810 in communication with a UE 850, where the NodeB 810 may one or more of base stations 102, 104, 106 and/or 108, and/or may include a joint power and resource manager 112 and/or transmit power calibrator component 122 and/or resource management component 132 (FIG. 1). In the downlink communication, a transmit processor 820 may receive data from a data source 812 and control signals from a controller/processor 840. The transmit processor 820 provides various signal processing functions for the data and control signals, as well as reference signals (e.g., pilot signals). For example, the transmit processor 820 may provide cyclic redundancy check (CRC) codes for error detection, coding and interleaving to facilitate forward error correction (FEC), mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM), and the like), spreading with orthogonal variable spreading factors (OVSF), and multiplying with scrambling codes to produce a series of symbols. Channel estimates from a channel processor 844 may be used by a controller/processor 840 to determine the coding, modulation, spreading, and/or scrambling schemes for the transmit processor 820. These channel estimates may be derived from a reference signal transmitted by the UE 850 or from feedback from the UE 850. The symbols generated by the transmit processor 820 are provided to a transmit frame processor 830 to create a frame structure. The transmit frame processor 830 creates this frame structure by multiplexing the symbols with information from the controller/processor 840, resulting in a series of frames. The frames are then provided to a transmitter 832, which provides various signal conditioning functions including amplifying, filtering, and modulating the frames onto a carrier for downlink transmission over the wireless medium through antenna 834. The antenna 834 may include one or more antennas, for example, including beam steering bidirectional adaptive antenna arrays or other similar beam technologies.

At the UE 850, a receiver 854 receives the downlink transmission through an antenna 852 and processes the transmission to recover the information modulated onto the carrier. The information recovered by the receiver 854 is provided to a receive frame processor 860, which parses each frame, and provides information from the frames to a channel processor 894 and the data, control, and reference signals to a receive processor 870. The receive processor 870 then performs the inverse of the processing performed by the transmit processor 820 in the NodeB 88. More specifically, the receive processor 870 descrambles and despreads the symbols, and then determines the most likely signal constellation points transmitted by the NodeB 88 based on the modulation scheme. These soft decisions may be based on channel estimates computed by the channel processor 894. The soft decisions are then decoded and deinterleaved to recover the data, control, and reference signals. The CRC codes are then checked to determine whether the frames were successfully decoded. The data carried by the successfully decoded frames will then be provided to a data sink 872, which represents applications running in the UE 850 and/or various user interfaces (e.g., display). Control signals carried by successfully decoded frames will be provided to a controller/processor 890. When frames are unsuccessfully decoded by the receiver processor 870, the controller/processor 890 may also use an acknowledgement (ACK) and/or negative acknowledgement (NACK) protocol to support retransmission requests for those frames.

In the uplink, data from a data source 878 and control signals from the controller/processor 890 are provided to a transmit processor 880. The data source 878 may represent applications running in the UE 850 and various user interfaces (e.g., keyboard). Similar to the functionality described in connection with the downlink transmission by the NodeB 88, the transmit processor 880 provides various signal processing functions including CRC codes, coding and interleaving to facilitate FEC, mapping to signal constellations, spreading with OVSFs, and scrambling to produce a series of symbols. Channel estimates, derived by the channel processor 894 from a reference signal transmitted by the NodeB 88 or from feedback contained in the midamble transmitted by the NodeB 88, may be used to select the appropriate coding, modulation, spreading, and/or scrambling schemes. The symbols produced by the transmit processor 880 will be provided to a transmit frame processor 882 to create a frame structure. The transmit frame processor 882 creates this frame structure by multiplexing the symbols with information from the controller/processor 890, resulting in a series of frames. The frames are then provided to a transmitter 856, which provides various signal conditioning functions including amplification, filtering, and modulating the frames onto a carrier for uplink transmission over the wireless medium through the antenna 852.

The uplink transmission is processed at the NodeB 88 in a manner similar to that described in connection with the receiver function at the UE 850. A receiver 835 receives the uplink transmission through the antenna 834 and processes the transmission to recover the information modulated onto the carrier. The information recovered by the receiver 835 is provided to a receive frame processor 836, which parses each frame, and provides information from the frames to the channel processor 844 and the data, control, and reference signals to a receive processor 838. The receive processor 838 performs the inverse of the processing performed by the transmit processor 880 in the UE 850. The data and control signals carried by the successfully decoded frames may then be provided to a data sink 839 and the controller/processor, respectively. If some of the frames were unsuccessfully decoded by the receive processor, the controller/processor 840 may also use an acknowledgement (ACK) and/or negative acknowledgement (NACK) protocol to support retransmission requests for those frames.

The controller/processors 840 and 890 may be used to direct the operation at the NodeB 810 and the UE 850, respectively. For example, the controller/processors 840 and 890 may provide various functions including timing, peripheral interfaces, voltage regulation, power management, and other control functions. The computer readable media of memories 842 and 892 may store data and software for the NodeB 810 and the UE 850, respectively. A scheduler/processor 846 at the NodeB 810 may be used to allocate resources to the UEs and schedule downlink and/or uplink transmissions for the UEs.

Several aspects of a telecommunications system have been presented with reference to a W-CDMA system. As those skilled in the art will readily appreciate, various aspects described throughout this disclosure may be extended to other telecommunication systems, network architectures and communication standards.

By way of example, various aspects may be extended to other UMTS systems such as TD-SCDMA, High Speed Downlink Packet Access (HSDPA), High Speed Uplink Packet Access (HSUPA), High Speed Packet Access Plus (HSPA+) and TD-CDMA. Various aspects may also be extended to systems employing Long Term Evolution (LTE) (in FDD, TDD, or both modes), LTE-Advanced (LTE-A) (in FDD, TDD, or both modes), CDMA2000, Evolution-Data Optimized (EV-DO), Ultra Mobile Broadband (UMB), IEEE 802.11 (Wi-Fi), IEEE 802.16 (WiMAX), IEEE 802.20, Ultra-Wideband (UWB), Bluetooth, and/or other suitable systems. The actual telecommunication standard, network architecture, and/or communication standard employed will depend on the specific application and the overall design constraints imposed on the system.

In accordance with various aspects of the disclosure, an element, or any portion of an element, or any combination of elements may be implemented with a “processing system” that includes one or more processors. Examples of processors include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software may reside on a computer-readable medium. The computer-readable medium may be a non-transitory computer-readable medium. A non-transitory computer-readable medium includes, by way of example, a magnetic storage device (e.g., hard disk, floppy disk, magnetic strip), an optical disk (e.g., compact disk (CD), digital versatile disk (DVD)), a smart card, a flash memory device (e.g., card, stick, key drive), random access memory (RAM), read only memory (ROM), programmable ROM (PROM), erasable PROM (EPROM), electrically erasable PROM (EEPROM), a register, a removable disk, and any other suitable medium for storing software and/or instructions that may be accessed and read by a computer.

The computer-readable medium may also include, by way of example, a carrier wave, a transmission line, and any other suitable medium for transmitting software and/or instructions that may be accessed and read by a computer. The computer-readable medium may be resident in the processing system, external to the processing system, or distributed across multiple entities including the processing system. The computer-readable medium may be embodied in a computer-program product. By way of example, a computer-program product may include a computer-readable medium in packaging materials. Those skilled in the art will recognize how best to implement the described functionality presented throughout this disclosure depending on the particular application and the overall design constraints imposed on the overall system.

It is to be understood that the specific order or hierarchy of steps in the methods disclosed is an illustration of exemplary processes. Based upon design preferences, it is understood that the specific order or hierarchy of steps in the methods may be rearranged. The accompanying method claims present elements of the various steps in a sample order, and are not meant to be limited to the specific order or hierarchy presented unless specifically recited therein.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112, sixth paragraph, unless the element is expressly recited using the phrase “means for” or, in the case of a method claim, the element is recited using the phrase “step for.”

What is claimed is:

1. A method for joint power and resource management in a wireless network, comprising:
receiving reference signal received power (RSRP) measurements of one or more neighboring base stations of a base station;
calibrating a transmit power of the base station based at least on the received measurements; and
adjusting transmit resources of the base station at least in response to the calibrating.

2. The method of claim 1, wherein the calibrating further comprises:
increasing or decreasing the transmit power of the base station based on the received measurements, wherein the base station is a serving base station of a user equipment (UE) that transmitted the RSRP measurements of the one or more neighboring base stations.

3. The method of claim 1, wherein the adjusting further comprises:
orthogonalizing the transmit resources of the base station relative to transmit resources of the one or more neighboring base stations.

4. The method of claim 3, wherein the orthogonalizing comprises orthogonalizing in a frequency or a time domain.

5. The method of claim 4, wherein the orthogonalizing in a frequency domain further comprises:
performing a fractional frequency reuse (FFR) or a soft FFR procedure.

6. The method of claim 1, wherein the RSRP measurements include RSRP measurements of common reference signals (CRS) of the one or more neighboring base stations.

7. The method of claim 1, further comprising:
increasing the base station transmit power temporarily to attract user equipments (UEs).

8. The method of claim 1, wherein the transmit power and the transmit resources of the base station are adjusted in a coordinated fashion to maximize a total network utility parameter while maintaining a given quality of service (QoS), wherein the total network utility parameter is a sum of rates of all UEs in a system.

9. The method of claim 1, wherein the performing and the adjusting can be based on at least one of network listen measurements or user equipment (UE) measurement reports.

10. The method of claim 1, wherein the RSRP measurements are received from one or more UEs served by the base station.

11. The method of claim 1, wherein the calibrating further comprises configuring a periodic transmission power level increase for a temporary time period, wherein the temporary time period may be chosen to sufficiently enable idle mode UEs to perform search and discover the increased power level from the base station.

12. The method of claim 1, wherein the calibrating further comprises configuring one or more mobility parameters for use by a user equipment (UE) being served by the base station, wherein the one or more mobility parameters comprise one or more dense network thresholds that reduce handover of the UE from the base station to one of the other base stations.

13. An apparatus for joint power and resource management in a wireless network, comprising:
means for receiving reference signal received power (RSRP) measurements of one or more neighboring base stations of a base station;
means for calibrating a transmit power of the base station based at least on the received measurements; and
means for adjusting transmit resources of the base station at least in response to the calibrating.

14. The apparatus of claim 13, wherein the means for calibrating further comprises:
means for increasing or decreasing the transmit power of the base station based on the received measurements, wherein the base station is a serving base station of a user equipment (UE) that transmitted the RSRP measurements of the one or more neighboring base stations.

15. The apparatus of claim 13 wherein the means for adjusting comprises:
means for orthogonalizing the transmit resources of the base station relative to transmit resources of the one or more neighboring base stations.

16. The method of claim 15, wherein the means for orthogonalizing further comprises means for orthogonalizing in a frequency or a time domain.

17. The method of claim 16, wherein the means for orthogonalizing in a frequency domain comprises means for performing a fractional frequency reuse (FFR) or a soft FFR procedure.

18. A computer program product for joint power and resource management in a wireless network, comprising:
a computer-readable medium comprising code executable by a computer for:
receiving reference signal received power (RSRP) measurements of one or more neighboring base stations of a base station;
calibrating a transmit power of the base station based at least on the received measurements; and
adjusting transmit resources of the base station at least in response to the calibrating.

19. The computer program product of claim 18, wherein the code for calibrating further comprises:
code for increasing or decreasing the transmit power of the base station based on the received measurements, wherein the base station is a serving base station of a user equipment (UE) that transmitted the RSRP measurements of the one or more neighboring base stations.

20. The computer program product of claim 18 wherein the code for adjusting further comprises:
code for orthogonalizing the transmit resources of the base station relative to transmit resources of the one or more neighboring base stations.

21. The computer program product of claim 20, wherein the code for orthogonalizing further comprises code for orthogonalizing in a frequency or a time domain.

22. The computer program product of claim 21, wherein the code for orthogonalizing in a frequency domain further comprises code for performing a fractional frequency reuse (FFR) or a soft FFR procedure.

23. An apparatus for joint power and resource management in a wireless network, comprising:
a joint power and resource manager to receive reference signal received power (RSRP) measurements of one or more neighboring base stations of a base station;
a transmit power calibrator component to calibrate a transmit power of the base station based at least on the received measurements; and
a resource management component to adjust transmit resources of the base station in response to the calibration.

24. The apparatus of claim 23, wherein the transmit power calibrator component is further configured to increase or decrease the transmit power of the base station based at least on the received measurements.

25. The apparatus of claim 23, wherein the resource management component is configured to orthogonalize the transmit resources of the base station relative to transmit resources of the one or more neighboring base stations.

26. The apparatus of claim 25, wherein the resource management component is further configured to orthogonalize in a frequency or a time domain.

27. The apparatus of claim 26, wherein the resource management component is further configured to orthogonalize in a frequency domain that includes a fractional frequency reuse (FFR) or a soft FFR.

28. The apparatus of claim 23, wherein the RSRP measurements comprise:
RSRP measurements of common reference signals (CRS) of the one or more other neighboring base stations.

29. The apparatus of claim 23, wherein the transmit power calibrator component is further configured to temporarily increase the transmit power of the base station to attract user equipments (UEs).

30. The apparatus of claim 23, wherein the joint power and resource manager is further configured to increase a total network utility while maintaining a given Quality of Service (QoS).

31. The apparatus of claim 23, wherein the transmit power calibrator component and resource management component are further configured based on at least one of network listen measurements and user equipment (UE) measurement reports.
